(19) United States
(12) Patent Application Publication
(10) Pub. No.: US 2025/0217642 A1
(43) Pub. Date: Jul. 3, 2025

(54) METHOD AND DEVICE FOR ENCRYPTING PARAMETER OF NEURAL NETWORK MODEL

(71) Applicant: Ju Han PARK, Daejeon (KR)

(72) Inventors: Ju Han PARK, Daejeon (KR); Haneol JANG, Daejeon (KR)

(21) Appl. No.: 18/999,787

(22) Filed: Dec. 23, 2024

(30) Foreign Application Priority Data
Dec. 28, 2023 (KR) 10-2023-0193942
Feb. 2, 2024 (KR) 10-2024-0016607
Mar. 13, 2024 (KR) 10-2024-0035219

(51) Int. Cl. G06N 3/08; G06N 3/0464; H04L 9/08

(52) U.S. Cl. CPC G06N 3/08; G06N 3/0464; H04L 9/0819

(57) ABSTRACT

Disclosed is a device for encrypting a parameter of a neural network model. The present disclosure may encrypt a neural network model by controlling changes to at least one of locations and values of parameters applied between a plurality of neurons constituting the neural network model, using a secret key. Accordingly, the security efficiency of the deep learning model can be improved by adding only simple operations to change and restore the locations of parameters, without degrading the performance or speed of the existing trained neural network model.

This application claims the benefit of and priority to Korea Patent Application No. 10-2023-0193942, filed on Dec. 28, 2023, No. 10-2024-0016607, filed on Feb. 2, 2024, 10-2024-0035219, filed on Mar. 13, 2024 the entire disclosure(s) of which is hereby incorporated herein by reference in its entirety.

### TECHNICAL FIELD

The present disclosure relates to a method and device for encrypting a parameter of a neural network model.

### BACKGROUND

Artificial intelligence technology may consist of machine learning and component technology that utilizes machine learning. Machine learning refers to an algorithm technology that autonomously classifies and learns the characteristics of input data, and the component technology refers to a technology that mimics human brain functions such as cognition and judgment by employing machine learning algorithms, including deep learning, and may consist of technology fields such as linguistic understanding, visual understanding, inference, prediction, knowledge representation, content generation, and motion control.

With recent advancements in image processing and camera device technologies, it is possible to recognize objects in images captured by cameras and implement various services using the recognized object information. Object recognition technology can enhance recognition accuracy through the training of neural network models designed for artificial intelligence-based image recognition. As a result, the quality of services in the field of visual understanding (including object recognition, object tracking, image search, human recognition, scene understanding, spatial understanding, image enhancement, and more) is improving. However, neural network models in fields such as object recognition are typically trained on images containing objects as training data.

Therefore, if a neural network model is unintentionally leaked, for instance, through hacking, it can lead to significant issues related to personal information breaches.

### SUMMARY

In view of the above, the present disclosure provides a method and device for encrypting a parameter of a neural network model by performing encryption on the neural network model itself, thereby addressing security issues such as personal information leakage that may arise from a leakage of the neural network model.

The technical problems to be solved by the present disclosure are not limited to the technical problems mentioned above, and other technical problems not mentioned may be clearly understood by a person having ordinary skill in the art to which the present disclosure belongs from the detailed description of the present disclosure below.

In one general aspect, there is provided a device for encrypting a parameter of a neural network model, and the device includes: a storage unit configured to store a pre-trained neural network model composed of a plurality of layers, each layer composed of elements to which individual parameters are applied; a secret key generation unit configured to generate a secret key; and a processor configured to encrypt the neural network model by changing at least one of locations and values of parameters, applied to the elements during a learning process, for at least one of the layers of the neural network model using the secret key, and store the encrypted neural network model in the storage unit.

The processor may encrypt the parameters of the neural network model after changing the values of the parameters and then changing locations where the changed values of the parameter are applied.

The processor may encrypt the parameters of the neural network model after changing the locations of the parameters and then changing the values of the parameters applied to the changed locations.

The secret key may include a combination of numbers or letters generated using a symmetric key algorithm, and a rule related to the combination of the numbers or letters.

The device may further include a communication unit for sharing the encrypted neural network model with an external device, and the processor may transmit the secret key along with the neural network model to the external device through the communication unit.

The neural network model may be trained by a convolution neural network (CNN), and the processor may control to change either or both a location of a first parameter applied to a convolution layer (CL) or a location of a second parameter applied to a fully connected layer (FC) using the secret key. Additionally, the processor may control to change at least one of a value and a location of a second parameter applied to a fully connected layer (FC) of a convolution neural network.

The neural network model may include a convolution neural network, and the processor may perform encryption of the neural network model by changing a matrix value of a kernel map used during a convolution operation for each pixel value of an input image using the secret key.

The processor may control the change of a location of a parameter by changing the location of the matrix value in the kernel map using the secret key.

The processor may control the change of the matrix value in the kernel map using a first secret key and the change of a location of a parameter to which the changed matrix value is applied using a second secret key.

In another aspect, there is provided a method for encrypting a parameter of a neural network model, and the method includes: generating a secret key for encrypting a parameter of a neural network model that is composed of a plurality of layers, each layer composed of elements to which individual parameters are applied; performing encryption on the neural network model by changing at least one of locations and values of parameters, applied to the elements during a learning process, for at least one of the layers using the secret key; and storing the encrypted neural network model in a memory.

Performing the encryption may include: changing the values of the parameters using the secret key; and changing the locations where the changed values of the parameters are applied.

The secret key may include a first secret key and a second secret key, and performing the encryption may include: changing the locations of the parameters using the first secret key; and after changing the locations of the parameters, changing the values of the parameters applied to the changed locations using the second secret key.

In yet another aspect, there is provided a device for encrypting a parameter of a neural network model, and the device includes: a memory having at least one program recorded therein; and a processor configured to execute the at least one program and execute instructions including an instruction to generate a secret key for encrypting a neural network model composed of a plurality of layers, each layer composed of elements to which individual parameters are applied; an instruction to change at least one of locations and values of the parameters, applied to the elements during a learning process, for at least one of the layers using the secret key; and an instruction to store the encrypted neural network model in the memory.

According to one embodiment of the present disclosure, by performing encryption on the neural network model itself, security issues such as personal information leakage resulting from a leakage of the neural network model may be addressed.

According to one embodiment of the present disclosure, the security efficiency of a deep learning model may be improved by simply adding operations for changing and restoring either or both values and locations of parameters, without degrading the performance or speed of an existing trained neural network model.

Effects of the present disclosure are not limited to the effects mentioned above, and other effects not mentioned may be clearly understood by those skilled in the art to which the present disclosure pertains, based on the following description.

### BRIEF DESCRIPTION OF THE DRAWINGS

The accompany drawings, which are included to provide a further understanding of the present disclosure and are incorporated on and constitute a part of the present disclosure illustrate embodiments of the present disclosure and together with the description serve to explain the principles of the present disclosure.

FIG. 1 is a block diagram of a computing device for implementing a parameter encryption method of a neural network model according to one embodiment of the present disclosure.

FIG. 2 is a diagram for explaining the structure of a neural network model according to one embodiment of the present disclosure.

FIG. 3 is a flowchart of a method for encrypting a parameter of a neural network model according to one embodiment of the present disclosure.

FIG. 4 is a flowchart to more specifically explain a method of encrypting a neural network model by changing at least one of a value or location of a parameter according to one embodiment of the present disclosure.

FIG. 5 illustrates an example of changing a parameter value of a neural network model using a secret key according to one embodiment of the present disclosure.

FIG. 6 illustrates an example of changing a parameter value and location of a neural network model together using a secret key according to one embodiment of the present disclosure.

FIG. 7 is a flowchart of a method for encrypting a neural network model according to another embodiment of the present disclosure.

FIG. 8 is a diagram illustrating a method of encrypting a neural network model by changing the location of parameters of a convolution layer in a convolution neural network according to one embodiment of the present disclosure.

FIG. 9 is a diagram illustrating a method for encrypting a neural network model by changing locations of parameters of a fully connected layer in a convolution neural network according to one embodiment of the present disclosure.

The accompany drawings, which are included to provide a further understanding of the present disclosure and are incorporated on and constitute a part of the present disclosure illustrate embodiments of the present disclosure and together with the description serve to explain the principles of the present disclosure.

### DETAILED DESCRIPTION

Hereinafter, description will now be given in detail according to exemplary embodiments disclosed herein, with reference to the accompanying drawings, and the same or equivalent components may be provided with the same or similar reference numbers, and description thereof will not be repeated. The suffixes “module” and “unit” of elements herein are used for convenience of description and thus may be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the accompanying drawings are provided for easy understanding of embodiments of the disclosure and do not limit technical spirits of the disclosure, and the embodiments should be construed as including all modifications, equivalents, and alternatives falling within the spirit and scope of the embodiments.

While terms including ordinal numbers, such as “first” and “second,” etc., may be used to describe various components, such components are not limited by the above terms. The above terms are used only to distinguish one component from another.

When a component is referred to as being “connected” or “accessed” to other component, it should be understood that not only is the component directly connected or accessed to the other component, but also, another component may exist therebetween. When a component is referred to as being “directly connected” or “directly accessed” to other component, it should be understood that there is no component therebetween.

The singular forms are intended to include the plural forms, unless the context clearly indicates a different meaning.

It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

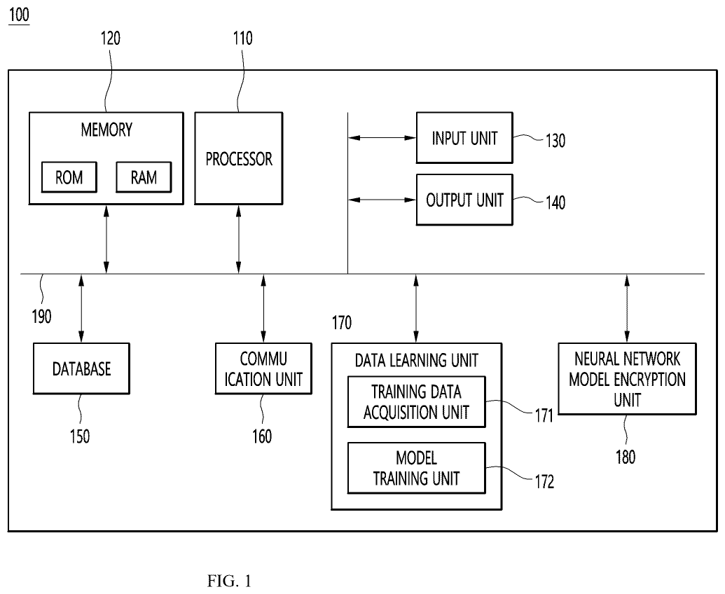

FIG. 1 is a block diagram of a computing device for implementing a parameter encryption method of a neural network model according to one embodiment of the present disclosure.

Referring to FIG. 1, a device 100 for encrypting a neural network model may, as a computer device, include at least one processor 110, a memory 120, an input unit 130, an output unit 140, a storage unit 150, a communication unit 160 connected to a network to perform communication, a data learning unit 170, and a neural network model encryption unit 180. Each component included in the device 100 may be connected by a bus 190 to communicate with each other.

The computing device may be a device in a cloud environment that provides AI processing results to other devices. The computing device 100 is a computing device capable of training a neural network and may be implemented as various electronic devices such as a server, a desktop PC, a notebook PC, a tablet PC, etc. Additionally, the computing device may be a device in an edge environment that performs data communication with a server in a cloud environment.

The processor 110 may train a neural network using a program stored in the memory 120 and/or storage 150. In particular, the processor 110 may train a neural network for the operation of the device 100. Here, the neural network for the operation of the device 100 may be designed to simulate the human brain structure on a computer, and may include a plurality of network nodes having weights that simulate neurons of the human neural network. A plurality of network modes may each send and receive data according to relationships of connection to each other to simulate a synaptic activity of neurons in which neurons send and receive signals through synapses. Here, the neural network may include a deep learning model developed from a neural network model. In a deep learning model, a plurality of network nodes may be located in different layers and exchange data based on their connection relationships. Examples of neural network models include various deep learning techniques such as deep neural networks (DNNs), convolutional deep neural networks (CNNs), recurrent Boltzmann machines (RNNs), restricted Boltzmann machines (RBMs), deep belief networks (DBNs), and deep Q-networks, and may be applied to fields such as computer vision, speech recognition, natural language processing, and speech/signal processing.

Meanwhile, the processor performing the functions described above may be a general-purpose processor (e.g., CPU), but may also be an AI-specific processor for artificial intelligence learning (e.g., GPU).

Each of the memory 120 and the storage 150 may be composed of at least one of a volatile storage medium and a non-volatile storage medium. For example, the memory 120 may be composed of at least one of a read only memory (ROM) and a random access memory (RAM).

The memory 120 may store various programs and data necessary for the operation of the device 100. The memory 120 may be implemented as non-volatile memory, volatile memory, flash memory, a hard disk drive (HDD), or a solid state drive (SDD). The memory 120 may be accessed by the processor 110, and data may be read, written, modified, deleted, or updated in the memory 120. Additionally, the memory 120 may store a neural network model (e.g., a deep learning model) created using a learning algorithm designed to train an AI model for image classification and/or generation according to one embodiment of the present disclosure.

Additionally, the processor 110 may execute a program command stored in at least one of the memory 120 and the storage 150. The program command may include an instruction to generate a secret key for encrypting a neural network model which has been previously learned and stored in memory, and an instruction to change a parameter location applied to the neural network model using the secret key. Here, the secret key may refer to a symmetric key used in a symmetric key algorithm, a public key or private key used in a public key algorithm, or a predefined number or rule used in an encryption algorithm.

Meanwhile, the processor 110 may include a data learning unit 170 that trains a neural network for functions of a neural network model, for example, data classification/recognition and/or text-to-image generation. For example, the data learning unit 170 may train criteria regarding which training data to use for data classification/recognition, data classification/recognition, or text-to-image generation, and how to classify and recognize data using the training data. The data learning unit 170 may acquire training data to be used for learning, and may train a deep learning model by applying the acquired training data to the deep learning model.

The data learning unit 170 may be implemented as at least one hardware chip installed in the device 100. For example, the data learning unit 170 may be implemented as a dedicated hardware chip for artificial intelligence (AI), or may be implemented as part of a general-purpose processor (CPU) or graphics processor (GPU) installed in the device 100. Additionally, the data learning unit 170 may be implemented as a software module. If the data learning unit 170 is implemented as a software module (or a program module including instructions), the software module may be stored in a non-transitory computer-readable medium. In this case, at least one software module may be provided by an operating system (OS) or by an application.

The data learning unit 170 may include a training data acquisition unit 171 and a model training unit 172.

The training data acquisition unit 171 may acquire training data required for a neural network model classifying and recognizing data and/or a neural network model generating content (items, etc.).

Using the acquired training data, the model training unit 172 may train a neural network model to have decision-making criteria regarding how to classify predetermined data or decision-making criteria regarding how to generate a final content using the training data. At this point, the model training unit 172 may train the neural network model through supervised learning, which uses at least part of the training data as decision-making criteria. Alternatively, the model training unit 172 may train the neural network model through unsupervised learning, which discovers decision-making criteria by autonomously learning using training data without guidance. In addition, the model training unit 172 may train the neural network model through reinforcement learning, based on a feedback on whether a result of a situational judgment is correct. Additionally, the model training unit 172 may train the neural network model using a learning algorithm such as error back-propagation or gradient descent.

Once the neural network model is trained, the model training unit 172 may store the trained neural network model in the memory.

The data learning unit 170 may further include a training data preprocessing unit (not shown) and a training data selection unit (not shown) to improve analysis results of a recognition model or to save resources or time required for creating a recognition model.

The training data preprocessing unit may preprocess the acquired data for use in learning for situational judgment. For example, the training data preprocessing unit may process the acquired data into a preset format so that the model training unit 172 can use the acquired training data for learning for image recognition and/or generation.

In addition, the training data selection unit may select data required for training from among the training data acquired by the training data acquisition unit 171 or training data preprocessed by the preprocessing unit. The selected training data may be provided to the model training unit 172.

Additionally, the data learning unit 170 may further include a model evaluation unit (not shown) to improve the analysis results of the neural network model.

The model evaluation unit may input evaluation data into the neural network model, and if an analysis result output from the evaluation data fail to satisfy a predefined standard, the model training unit 172 may be caused to perform training again. In this case, the evaluation data may be predefined data for evaluating the recognition model. For example, if the number or percentage of the trained recognition model's incorrect analysis results for evaluation data exceeds a preset threshold, the model evaluation unit may evaluate the trained recognition model as failing to satisfy the predetermined standard.

The present disclosure discloses a method for encrypting a neural network model to enhance security against leakage of a neural network model in case a previously trained neural network model is stolen or leaked by an attacker. The present disclosure relates to various applications of a neural network and provides explanations of terms and concepts for easier understanding.

A neural network may include neurons. A neuron may be an operational unit that takes Xs and an intercept of 1 as inputs. An output of the operational unit may be expressed as follows.

$${h}_{W , b} ( x ) = f ( {W}^{T} x ) = f ( {Σ}_{s = 1}^{n} {W}_{s} {x}_{s} + b )$$

Here, s=1, 2, . . . , n, where n is a natural number greater than 1, Ws is the weight of Xs, and b is the bias of the neuron. In addition, f represents the activation function of a neuron, and is used to introduce nonlinear characteristics into a neural network to transform an input signal within the neuron into an output signal. An output signal of the activation function may serve as an input to a next convolutional layer, and the activation function may be a sigmoid function. A neural network is a network that is constructed by connecting a plurality of single neurons together. Specifically, the output of a neuron may be an input to another neuron. An input to each neuron is connected to a local receptive field of a previous layer, so that the features of the local receptive field may be extracted. Here, the local receptive field may refer to a region that contains a plurality of neurons.

A deep learning network (DNN), also known as a multilayer neural network, refers to a neural network with a plurality of hidden layers. The DNN is divided based on the locations of different layers. The neural networks within a DNN may be divided into three types (input layer, hidden layer, and output layer). In general, the layers may be fully connected. For example, an arbitrary neuron in an i-th layer is necessarily connected to an arbitrary neuron in an (i+1)-th layer. DNNs are generally expressed through the following linear equation.

$$\vec{y} = α ( W \vec{x} + \vec{b} )$$

Here, \vec{x} represents an input vector, \vec{y} represents an output vector, \vec{b} represents an offset vector, W represents a weight matrix (parameter), and α( ) represents an activation function. In each layer, the output vector \vec{y} is obtained by performing a simple operation on the input vector \vec{x}. Due to the large number of DNN layers, there also exist numerous coefficients W and offset vectors \vec{b}. These parameters may be defined in the DNN as follows. Taking the parameter W as an example, in a 3-layer DNN, a linear coefficient between a fourth neuron in a second layer and a second neuron in a third layer may be defined as W₂₄³. Here, the superscript 3 indicates the layer number where the coefficient W is located, and the subscripts correspond to the index 2 of the output in the third layer and the index 4 of the input in the second layer. Consequently, the parameter between the k-th neuron in the (L−1)-th layer and the j-th neuron in the L-th layer may be defined as Wⱼₖ^{L}. According to one embodiment of the present disclosure, changing a parameter value of a previously trained neural network model may mean changing the value of the weight “W” using a secret key generated through a predetermined encryption algorithm. Furthermore, according to another embodiment, changing a parameter location of a previously trained neural network model may refer to changing a final parameter value used by the input from the N-th neuron in M-th layer to the output from the N+first neuron in (M+1)-th layer to a different parameter value. Here, changing the parameter value may be understood as only changing the location of the parameter, rather than creating a new parameter through a predetermined operation. In other words, in a previously trained and stored neural network model, where the parameter between the k-th neuron in the (L−1)-th layer and the j-th neuron in the L-th layer is W1ⱼₖ^{L}, and the parameter between the (k+1)-th neuron in the (L−1)-th layer and the (j−1)-th neuron in the L-th layer is Wc2_{j-1 k+1}^{L}, the present disclosure proposes encrypting the neural network model. By utilizing a secret key, the parameter between the k-th neuron in the (L−1)-th layer and the j-th neuron in the L-th layer is changed to W2ⱼₖ^{L}, and the parameter between the (k+1)-th neuron in the (L−1)-th layer and the (j−1)-th neuron in the L-th layer is changed to W1_{j-1 k+1}^{L}. This process involves either changing a value of a parameter between neurons within the previously trained neural network model or changing a location of the parameter.

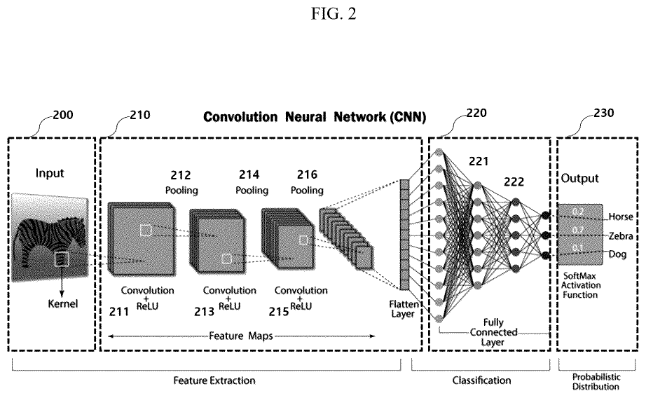

As an example of the neural network model disclosed in the present disclosure, a convolution neural network (CNN) is a deep neural network with a convolutional structure. Since the CNN is a general neural network, the CNN structure may be described in detail with reference to FIG. 2.

FIG. 2 is a diagram for explaining the structure of a neural network model according to one embodiment of the present disclosure.

A convolution neural network (CNN) is a deep neural network with a convolutional structure and is a deep learning architecture. The deep learning architecture performs multi-level learning at different levels of abstraction by using a neural network model updating algorithm. The CNN is a feed-forward artificial neural network. Each neuron in the feed-forward artificial neural network responds to an image input into the feed-forward artificial network. Taking a look at the CNN structure shown in FIG. 2 to explain a method for encrypting a neural network model according to one embodiment of the present disclosure, the CNN structure shown in FIG. 2 may include an input layer 200, a convolution layer/pooling layer 210 (wherein the pooling layer may be optional), and a fully connected layer 220. The input layer 200 acquires an image to be processed, and transmits the acquired image to the convolution layer/pooling layer 210 and the subsequent fully connected layer 220 for image processing, obtaining an image processing result.

The convolution layer/pooling layer 210 may include, for example, layers 211 to 216. For example, according to one embodiment, a layer 211 is a convolution layer, a layer 212 is a pooling layer, a layer 213 is a convolution layer, a layer 214 is a pooling layer, a layer 215 is a convolution layer, and a layer 216 is a pooling layer. Specifically, an output from a convolution layer may be used as an input to a subsequent pooling layer or as an input to another convolution layer, thereby continuing a convolution operation.

The convolution layer 211 may include a plurality of convolution operators. Each convolution operator may also be referred to as a kernel (or convolution kernel, filter, etc.). In image processing, each convolution operator function as a filter that extracts specific information from an input image matrix. Each convolution operator may essentially be a weight matrix, and the weight matrix is usually predefined. In the process of performing a convolution operation on an image, a weight matrix typically processes pixels at a granularity level of 1 pixel (or 2 pixels depending on a stride value) in a horizontal direction of the input image to extract predetermined features from the image. The size of the weight matrix is related to the size of the image. A depth dimension of the weight matrix may be the same as a depth dimension of the input image. During the convolution operation, the weight matrix extends to the entire depth of the input image. The outputs of the weight matrices are concatenated to form the depth dimension of the convolutional image. To extract different features from the input image, different weight matrices may be used. For example, a first weight matrix may be used to extract edge information from an image, the second weight matrix may be used to extract a specific color from the image, and the third weight matrix may be used to blur unwanted noise in the image. The plurality of weight matrices have the same size (M×N matrices), and convolutional feature maps extracted from these weight matrices of the same size also have the same size. Next, the plurality of extracted convolutional feature maps of the same size are combined to form an output of the convolution operation.

Weight (parameter) values in these weight matrices should be acquired through various learning processes, and the respective weight matrices, formed using the weight values obtained during the learning process, may be used to extract information from the input image, enabling the convolution neural network to perform accurate predictions.

When a convolution neural network has a plurality of convolutional layers, a convolutional layer (e.g., the layer 211) typically extracts more general features. The general features may also be referred to as low-level features. As the depth of the convolution neural network increases, a deeper convolutional layer (e.g., the layer 215) extract more complex features, such as high-level semantic features. The high-level semantic features may be directly applied to a problem to be solved.

The pooling layers 212, 214, and 216 are usually applied after the convolutional layers to reduce the number of learning parameters. During image processing, the pooling layers are used only to reduce the spatial size of the image. A pooling layer may include an average pooling operator and/or a max pooling operator to perform sampling on the input image, thereby obtaining an image with a reduced size. An average pooling operator may generate an average by calculating pixel values within a predetermined range of an image. The average value is used as an average pooling result. The max pooling operator may select a pixel with a maximum value within a predetermined range as a max pooling result. Moreover, just as the size of a weight matrix in a convolutional layer is related to the size of an image, the size of an operator in a pooling layer is also related to the size of the image. The size of a processed image output from the pooling layer may be smaller than the size of an image input to the pooling layer. Each pixel in the image output from the pooling layer represents the average value (average pooling) or maximum value (max pooling) of a corresponding sub-region in the image input to the pooling layer.

Even after the computational processing by the convolutional layer and/or pooling layer 210, the convolution neural network cannot produce a final output. The convolution layer and/or pooling layer 210 extracts only features and reduces the parameters extracted from the input image. However, in order to generate the final output information (e.g., desired class information or other relevant data), the convolution neural network utilizes the fully connected layer 220 to produce the output of a single desired class or the outputs of a group of desired classes. Therefore, the fully connected layer 220 may include a plurality of hidden layers (layers 221 and 222 as shown in FIG. 2) and an output layer 230. Parameters included in the plurality of hidden layers may be obtained through pre-learning based on relevant training data for a specific task type. Here, a task type may refer to image recognition, image classification, super-resolution image reconstruction, etc.

In the fully connected layer 220, the output layer 230, which is the final layer of the entire convolution neural network, follows the plurality of hidden layers. The output layer 230 has a loss function similar to categorical cross entropy, and the loss function may be configured to calculate a prediction error.

When the forward propagation of the convolution neural network (e.g., from 200 to 230 in FIG. 2) is complete, backward propagation (e.g., from 230 to 200 in FIG. 2) begins, and this process updates a weight (parameter) value and bias of each layer as described earlier, thereby reducing an error between an actual output of the convolution neural network and an ideal result, and the error reduction is achieved by leveraging the loss function and the output layer of the convolution neural network.

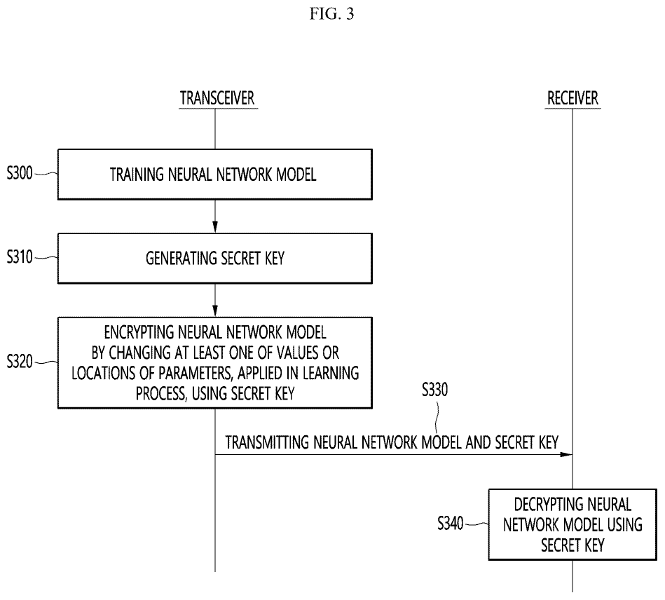

FIG. 3 is a flowchart of a method for encrypting a parameter of a neural network model according to one embodiment of the present disclosure. The method for encrypting a parameter of a neural network model, as illustrated in FIG. 3, may be implemented through the processor 110 or the processor 110 and the neural network model encryption unit 180 of FIG. 1.

Referring to FIG. 3, the processor 110 may train a neural network model (S300). The processor 110 may store a parameter generated through a learning process of the neural network model, along with the neural network model itself, in memory.

The processor 110 may generate a secret key for encrypting the neural network model (S310). The secret key may include a combination of numbers or letters generated using a symmetric key algorithm, and a rule related to the combination of the numbers or letters. For an encryption algorithm using the secret key, any known secret key algorithm may apply.

The processor 110 encrypts the neural network model by changing at least one of values and locations of parameters of a pre-trained neural network model using the secret key or by sequentially changing the values of the parameters and the locations of the parameters (S320).

According to one embodiment, the processor 110 may perform model encryption by changing a location of a first parameter applied to a convolution layer or by changing a value of a second parameter applied to a fully connected layer using the secret key. In addition, the processor 110 may perform model encryption by changing the value of the first parameter applied to the convolution layer using the secret key and additionally changing the location of the first parameter. In addition, the processor 110 may perform model encryption by changing the location of the second parameter applied to the fully connected layer and additionally change the value of the second parameter at the changed location using the secret key. While the foregoing examples describe an example of changing the location and/or value of a parameter in the convolutional layer and/or the fully connected layer, and an example of sequentially changing the location and/or value of the parameter, the order of changing the location of the parameter and changing the value of the parameter may be adaptively modified based on implementation needs.

According to one embodiment of the present disclosure, encrypting a neural network model to change locations and/or values of parameters may include, but is not limited to, changing the locations and/or values of the parameters using the secret key when the learning of the neural network model is complete and the neural network model is stored in a memory, as described above. For example, before a trained neural network is stored in memory, a neural network model may be encrypted by sequentially changing at least one or more of the parameter locations or values using the secret key and then stored in memory.

As described above, it may be understood that the processor 110 does not perform relearning or model update in order to change the first parameter applied during the training of the neural network layer to a new parameter, but instead the processor 110 changes the location of a node or pixel to which the first parameter is applied or changes the value of the first parameter applied to the node or pixel.

Meanwhile, in FIG. 3, a transmitter is a device in which neural network model training is performed and a device that encrypts the trained neural network model. For example, the transmitter may be an edge device such as a CCTV. CNN model training is performed based on a plurality of images captured by a CCTV, and a parameter location change algorithm is applied to the stored neural network model for encryption. Meanwhile, the receiver normally requests a neural network model from the transmitter, and receives the neural network model and a secret key applied to the encryption of the neural network model from the transmitter (S330). The receiver may use the received secret key to decrypt the neural network model and use the normal neural network model.

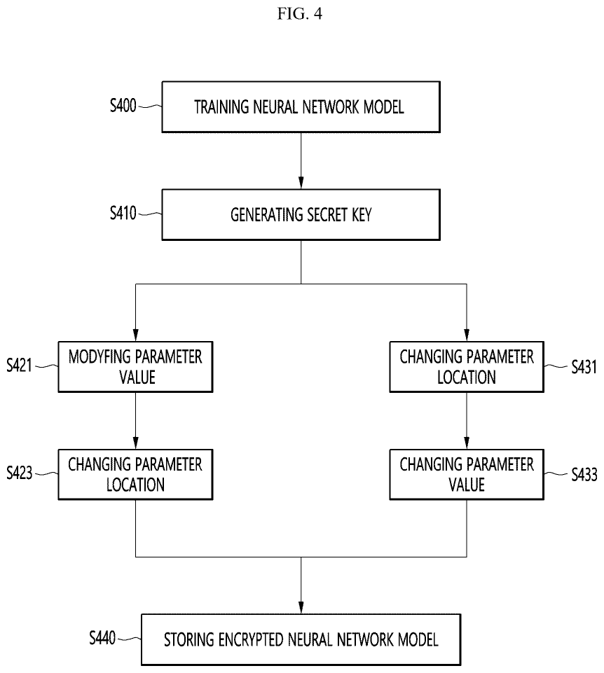

FIG. 4 is a flowchart to more specifically explain a method of encrypting a neural network model by changing at least one of a value or location of a parameter according to one embodiment of the present disclosure.

The processor 110 may train a neural network model (S400). When training of the neural network model is completed and parameters are finally determined, the processor 110 may generate a secret key to be used for encrypting the neural network model (S410).

The processor 110 may change a value of a parameter applied to the trained neural network using the secret key (S421) and additionally change a location of the parameter (S423). The processor 110 may store the neural network model in which the value and location of the parameter are sequentially changed and encrypted (S440).

Additionally, according to one embodiment, the processor 110 may first change the location of the parameter using a secret key generated for the trained neural network model (S431), then change the value of the parameter applied to the changed location to encrypt the neural network model (S433), and store the encrypted model in memory (S440).

Accordingly, in order to properly restore the encrypted neural network model, an encryption algorithm and secret key information used during encryption must be transmitted together to enable the restoration of the neural network model.

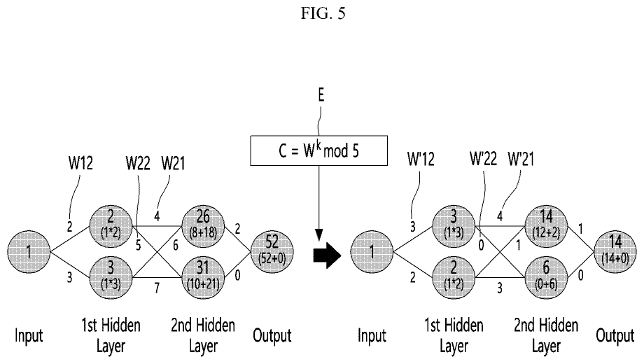

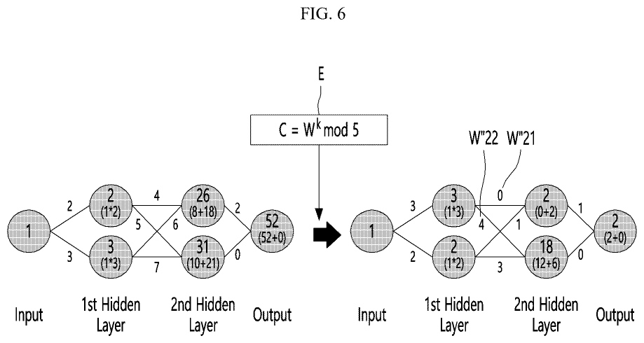

FIG. 5 illustrates an example of changing a parameter value of a neural network model using a secret key according to one embodiment of the present disclosure. FIG. 6 illustrates an example of changing a parameter value and location of a neural network model together using a secret key according to one embodiment of the present disclosure.

The processor 110 may train a neural network model (S400). When the training of the neural network model is completed and the parameters are finally determined, the processor 110 may generate a secret key to be used for encrypting the neural network model.

Referring to FIG. 5, the neural network model has been trained in a state where a first node of a first hidden layer is connected to a first node of a second hidden layer with a weight of “4” and to a second node of the second hidden layer with a weight of “5”, while a second node of the first hidden layer is connected to the first node of the second hidden layer with a weight of “4” and to the second node of the second hidden layer with a weight of “7”.

Referring to FIG. 5, an encryption algorithm applied in encryption of the neural network model, according to one embodiment of the present disclosure, may be an algorithm using a modulo operation. For example, the encryption algorithm may be represented C=W^{k} mod 5.

The processor 110 may generate an encrypted parameter value using the secret key k to change a value of parameter W. For example, in FIG. 5, if the secret key k is 3, the parameter W12 between the input value and the first neuron of the first hidden layer is “2” which may be changed to 3 (W′12) by the encryption algorithm “3=2³ mod 5.” Similarly, the parameter W21 from the first neuron of the first hidden layer to the first neuron of the second hidden layer is “4” which remains unchanged as 4 (W′21) by “4=4³ mod 5.” The parameter W22 from the first neuron of the first hidden layer to the second neuron of the second hidden layer is “5” which is changed to 0 by “0=5³ mod 5.” Accordingly, in FIG. 5, the output value of the neural network model before encryption is “52”, but, after a predetermined secret key is generated and an encryption algorithm (modular operation) are applied using the secret key, the output value becomes “14”. That is, even if the neural network model is leaked, an attacker does not know the secret key and the encryption algorithm to which the secret key is applied cannot restore the parameter values used in the neural network model, resulting in different output values.

Referring to FIG. 6, in a state where a parameter value is changed using the secret key in FIG. 5, the processor 110 may change the location where the parameter is applied. For example, the processor 110 may change the locations of the weights W′21 and W′22 using the secret key in a state where the parameter values have already been changed so that the first node of the first hidden layer is connected to the first node of the second hidden layer with the weight “4 (W′21)” and the first node of the first hidden layer is connected to the second node of the second hidden layer with the weight “0 (W′22).” Accordingly, a neural network model with a changed parameter location produces a result that is different from a result produced from the neural network model where the parameter location is not changed.

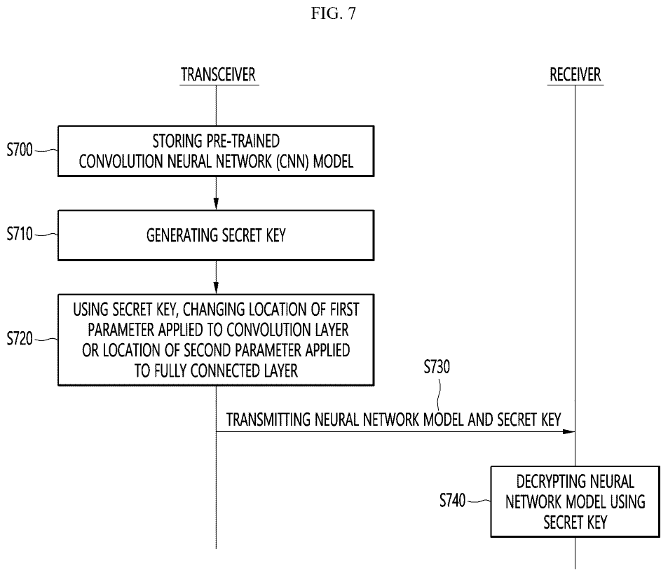

FIG. 7 is a flowchart of a method for encrypting a neural network model according to another embodiment of the present disclosure. The method for encrypting a neural network model, as illustrated in FIG. 7, may be implemented through the processor 110 or the processor 110 and the neural network model encryption unit 180 of FIG. 1.

Referring to FIG. 7, the processor 110 may store a pre-trained convolution neural network (CNN) model in a memory (S300). The processor 110 may store a parameter generated through a learning process of the neural network model, along with the neural network model itself, in memory.

The processor 110 may generate a secret key for encrypting a CNN model (S710). An encryption algorithm using a secret key may apply a secret key algorithm, and the present disclosure changes the location of parameters of a pre-trained neural network model using the secret key.

The processor 110 may perform model encryption by changing a location of a first parameter applied to a convolution layer or changing a location of a second parameter applied to a fully connected layer using the secret key (S720).

According to one embodiment of the present disclosure, encrypting a neural network model by change a location of a parameter, but is not limited to, changing the locations of the parameters using the secret key when the learning of the neural network model is complete and the neural network model is stored in memory, as described above. For example, before a trained neural network is stored in memory, a neural network model encrypted by changing a location of a parameter using the secret key may be stored in memory.

As described above, it may be understood that the processor 110 does not perform relearning or model update in order to change the first parameter applied during the training of the convolutional layer to a new parameter, but instead the processor 110 changes the location of a node or pixel to which the first parameter is applied. On the other hand, it may also be understood that the processor 110 does not perform relearning or reflect the results of relearning to change a location of a second parameter applied to the fully connected layer in order to generate a new parameter applied among a plurality of nodes constituting the fully connected layer (for example, a plurality of nodes belonging to the first hidden layer and the second hidden layer), but instead, the processor 110 changes only the location of the parameter applied between the nodes, and in the present disclosure, the encrypted neural network model to which the location-changed parameter are applied using the secret key is stored.

Meanwhile, in FIG. 7, the transmitter is a device in which neural network model training is performed and a device that encrypts the trained neural network model. For example, the transmitter may be an edge device such as a CCTV. CNN model training is performed based on a plurality of images captured by a CCTV, and a parameter location change algorithm is applied to the stored neural network model for encryption. Meanwhile, the receiver normally requests a neural network model from the transmitter, and receives the neural network model and a secret key applied to the encryption of the neural network model from the transmitter (S330). The receiver may use the received secret key to decrypt the neural network model and use the normal neural network model.

Meanwhile, as disclosed in S720, the present disclosure performs a location change of the first parameter applied to a convolutional layer in a convolution neural network and/or a location change of the second parameter applied to a fully connected layer using the secret key. That is, the processor 110 may perform encryption on at least one of a convolutional layer parameter and a fully connected layer parameter.

Hereinafter, how to encrypt the first parameter (convolutional layer parameter) and the encryption of the second parameter (fully connected layer parameter) described above will be described in more detail with reference to FIGS. 4 and 5.

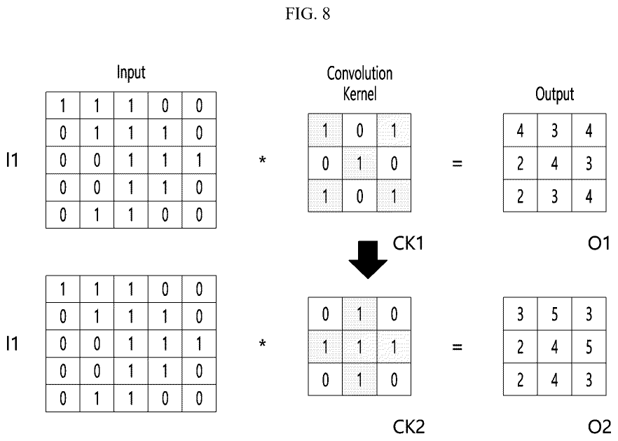

FIG. 8 is a diagram illustrating a method of encrypting a neural network model by changing the location of parameters of a convolution layer in a convolution neural network according to one embodiment of the present disclosure.

Referring to FIG. 8, with the same input image I1 applied, the processor 110 may change the locations of the matrix value “1” at (1,1) and the matrix value “0” at (1,2) in the 3*3 matrix of a first convolution kernel map CK1 using a generated secret key. The locations of the matrix value “1” at (1,3) and the matrix value “0” at (3,2) are changed, and similarly, the locations of the matrix value “1” at (3,3) and the matrix value “0” at (2,3) are changed, and the locations of the matrix value “1” at (3,1) and the matrix value “0” at (2,2) may be changed as well.

A specific method for changing a location of a matrix value within a kernel map using a secret key may be implemented using a combination of a secret key, a hash algorithm, a salt, a parameter sequence, and a random order generator.

In one embodiment, the secret key is a key shared between the sender and receiver and used for message encryption and decryption. The hash algorithm hashes an input value to produce a fixed-length bit output value, and the SHA-256 hash algorithm may be used. Salt may be a random number used to enhance hash security and shared in advance between a sender and a receiver. A parameter sequence refers to an ordered sequence with a length equal to the number of parameters; for example, if the length is 5, the sequence may be [0,1,2,3,4]. For the random order generator, a pseudo-random number generator algorithm that generates a different random value based on an initial seed value may be applied. According to one embodiment, a random sequence may be generated using a random generation algorithm such as a Permuted Congruential Generator (64-bit, PCG64).

According to one embodiment, the processor 110 may generate a sequence of parameters to be encrypted. The processor 110 may generate a hash result value (digest) for a secret key and salt using the hash algorithm and convert the hash result value into an integer value. Here, an input value for the hash may be data obtained by concatenating a bit sequence of the secret key and a bit sequence of the salt. Additionally, if the hash result value exceeds an integer range, part of a bit sequence of a hash output value may be truncated and converted into an integer value for use. The processor 110 may set the hash output value as an initial value (seed) of a random sequence generator and generate a random parameter sequence through the random sequence generator. If the generated random parameter sequence is [2,1,3,0,4], the aforementioned sequence may change the locations (orders) of the parameters from [value 0, value 1, value 2, value 3, value 4] to [value 2, value 1, value 3, value 0, value 4].

Using the aforementioned secret key, the locations of the parameters in a neural network model according to training of the neural network model may be changed. In doing so, the arrangement of matrix values in the first kernel map CK1 may be changed to the arrangement of matrix values in a second kernel map CK2. If a neural network model with parameters encrypted using the second kernel map CK2 is leaked, an output result of the neural network model may be a second output result O2 that differs from a first output result O1 from due to an attacker. In a receiver that has received both the neural network model and the secret key, the kernel map applied to the neural network model may be decrypted from the second kernel map CK2 to the first kernel map CK1 using the secret key, enabling the use of the previously trained neural network model.

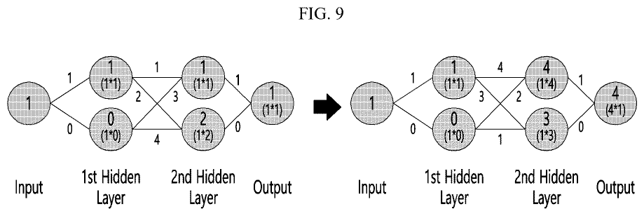

FIG. 9 is a diagram illustrating a method for encrypting a neural network model by changing locations of parameters of a fully connected layer in a convolution neural network according to one embodiment of the present disclosure.

Referring to FIG. 9, the processor 110 may perform encryption using a secret key on a parameter applied to a fully connected layer of a convolution neural network. The fully connected layer includes a plurality of hidden layers between a plurality of input nodes and a plurality of output nodes, and a first hidden layer and a second hidden layer may each include a plurality of nodes (neurons) that constitute the corresponding hidden layer. The plurality of nodes in each hidden layer are processed based on weights (parameters) and connected to nodes of a next hidden layer. For example, a neural network model has been trained in a state where a first node of the first hidden layer is connected to a first node of the second hidden layer with a weight of “1” and connected to the second node of the second hidden layer with a weight of “2,” while a second node of the first hidden layer is connected to the first node of the second hidden layer with a weight of “3” and to the second node of the second hidden layer with a weight of “4.” Using the secret key, the processor 110 may change the locations of the weights so that the first node of the first hidden layer is connected to the first node of the second hidden layer with a weight of “4” and to the second node of the second hidden layer with a weight of “3,” while the second node of the first hidden layer is connected to the first node of the second hidden layer with a weight of “2” and to the second node of the second hidden layer with a weight of “1.” Accordingly, a neural network model with a changed parameter location produces a result that is different from a result produced from the neural network model where the parameter location is not changed.

In the present disclosure, one or more of a surveillance camera, an autonomous vehicle, a user terminal, and a server may be linked to an artificial intelligence (AI) module, a robot, an augmented reality (AR) device, a virtual reality (VT) device, a device related to a 5G service, etc.

In order to minimize security issues of personal information due to neural network model leakage, the present disclosure improves the encryption strength of a neural network model by applying parameters applied to the neural network model using a secret key, for example, by changing the locations of the parameters, the values of the parameters, or a combination thereof.

The present disclosure described above may be implemented as a computer-readable code on a medium in which a program is recorded. A computer-readable media may include all kinds of recording devices for storing data that is readable by a computer system. Examples of computer-readable media include hard disk drives (HDDs), solid-state drives (SSDs), silicon disk drives (SDDs), ROMs, RAMs, CD-ROMs, magnetic tapes, floppy disks, optical data storage devices, as well as media implemented in the form of carrier waves (e.g., transmitted over the Internet). Accordingly, the foregoing detailed description should not be interpreted as restrictive in all aspects, and should be considered as illustrative. The scope of the present disclosure should be determined by rational interpretation of the appended claims, and all changes within the equivalent scope of the present disclosure are included in the scope of the present disclosure.

What is claimed is:

1. A device for encrypting a parameter of a neural network model, the device comprising:
a storage unit configured to store a pre-trained neural network model composed of a plurality of layers, each layer composed of elements to which individual parameters are applied;
a secret key generation unit configured to generate a secret key; and
a processor configured to encrypt the neural network model by changing at least one of locations or values of parameters, applied to the elements during a learning process, for at least one of the layers of the neural network model using the secret key, and store the encrypted neural network model in the storage unit.

2. The device of claim 1, wherein the processor encrypts the parameters of the neural network model after changing the values of the parameters and then changing locations where the changed values of the parameter are applied.

3. The device of claim 1, wherein the processor encrypts the parameters of the neural network model after changing the locations of the parameters and then changing the values of the parameters applied to the changed locations.

4. The device of claim 1, wherein the secret key comprises a combination of numbers or letters generated using a symmetric key algorithm, and a rule related to the combination of the numbers or letters.

5. The device of claim 1, further comprising a communication unit for sharing the encrypted neural network model with an external device,
wherein the processor transmits the secret key along with the neural network model to the external device through the communication unit.

6. The device of claim 1, wherein the processor controls to change locations of parameters applied to a fully connected layer (FC) comprising a plurality of hidden layers between a plurality of input nodes and a plurality of output nodes, so that locations of parameters applied to a plurality of nodes respectively constituting a first hidden layer and a second hidden layer are changed using the secret key.

7. The device of claim 6,
wherein the neural network model is trained by a convolution neural network (CNN), and
wherein the processor controls to changes either or both a location of a first parameter applied to a convolution layer (CL) or a location of a second parameter applied to a fully connected layer (FC) using the secret key.

8. The device of claim 1, wherein the processor controls to change the locations of the parameters by changing a kernel map for each pixel value of an input image and locations of matrix values in the kernel map, used during a convolution operation, using the secret key.

9. A method for encrypting a parameter of a neural network model, the method comprising:
generating a secret key for encrypting a parameter of a neural network model that is composed of a plurality of layers, each layer composed of elements to which individual parameters are applied;
performing encryption on the neural network model by changing at least one of locations or values of parameters, applied to the elements during a learning process, for at least one of the layers using the secret key; and
storing the encrypted neural network model in a memory.

10. The method of claim 9, wherein performing the encryption comprises:
changing the values of the parameters using the secret key; and
changing the locations where the changed values of the parameters are applied.

11. The method of claim 9,
wherein the secret key comprises a first secret key and a second secret key,
wherein performing the encryption comprises:
changing the locations of the parameters using the first secret key; and
after changing the locations of the parameters, changing the values of the parameters applied to the changed locations using the second secret key.

12. The method of claim 11, wherein performing the encryption comprises changing the locations of the parameters by changing locations of matrix values in the kernel map, used during a convolution operation, for each pixel of an input image using the secret key.

13. The method of claim 9,
wherein the neural network model comprises a convolution neural network (CNN) model, and
wherein performing the encryption comprises performing model encryption to change a location of a first parameter applied to a convolution layer or to change a location of a second parameter applied to a fully connected layer using the secret key.

14. The method of claim 13, wherein performing the encryption comprises changing locations of parameters applied between a plurality of nodes constituting each of a first hidden layer and a second hidden layer (second Hidden Layer) of the fully connected layer using the secret key.

15. A device for encrypting a parameter of a neural network model, the device comprising:
a memory having at least one program recorded therein; and
a processor configured to execute the at least one program and execute instructions comprising:
an instruction to generate a secret key for encrypting a neural network model composed of a plurality of layers, each layer composed of elements to which individual parameters are applied;
an instruction to change at least one of locations or values of the parameters, applied to the elements during a learning process, for at least one of the layers using the secret key; and
an instruction to store the encrypted neural network model in the memory.
